(19) United States
(12) Patent Application Publication
(10) Pub. No.: US 2004/0050237 A1
(43) Pub. Date: Mar. 18, 2004

(54) Apparatus and method for storing and reproducing music file

(75) Inventor: Seung-Yong Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/444,093

(22) Filed: May 23, 2003

(30) Foreign Application Priority Data
Sep. 14, 2002 (KR) 2002-56014

(51) Int. Cl. G10H 1/00

(52) U.S. Cl. 84/600

(57) ABSTRACT

An apparatus for storing music files, includes a link process unit which links a number of input music files with one another in consideration of a correlation of the music files, and a music file storage unit which stores the music files linked with one another through the link process unit. Accordingly, the music files can be reproduced in an order predetermined in consideration of the correlation of the music files, or in an order designated by a user.

### CROSS-REFERENCE TO RELATED APPLICATIONS

This application claims the benefit of Korean Patent Application No. 2002-56014, filed on Sep. 14, 2002, in the Korean Intellectual Property Office, the disclosure of which is incorporated herein by reference.

### BACKGROUND OF THE INVENTION

1. Field of the Invention

The present invention relates to an apparatus and method of storing and reproducing music files, and more particularly, to an apparatus and method of storing and reproducing a number of music files in consideration of a correlation between the music files.

2. Description of the Related Art

Audio devices which store and reproduce music files such as MP3 files are becoming increasingly popular. An MP3 device is an audio device which compresses and stores audio data in accordance with an MPEG layer 3, and decodes and reproduces the stored audio data. While mechanisms for storing and reproducing MP3 files can be incorporated into a single system, it is conventional to embody the MP3 device into two separated systems, for example, a computer system and an MP3 player. The computer system compresses audio data into MP3 data, and stores the MP3 data as an MP3 file, while the MP3 player receives, stores, and decodes the MP3 file transmitted from the computer system.

When audio data is input to an MP3 device, an encoder thereof compresses the audio data into MP3 data, and the compressed audio data, i.e., the MP3 data, is stored as an MP3 file in the MP3 system. In general, the MP3 file is identified by a name, e.g., a music title and a name of a musician. Therefore, in a case of reproducing a number of MP3 files, a conventional MP3 device sorts the MP3 files based on their names and reproduces the MP3 files in the sorted order.

However, despite the fact that certain MP3 files are correlated, and accordingly, a reproduction order of such correlated MP3 files is predetermined, the predetermined reproduction order is occasionally disordered. For example, in a case where the MP3 files are included in an album, it may be desirable that the MP3 files are reproduced in a predetermined order in the album. However, since conventional MP3 devices reproduce the MP3 files in the sorted order as described above while ignoring the predetermined reproduction order, whenever a user wishes to reproduce a number of MP3 files, the user has to select the MP3 files and determine a reproduction order thereof with reference to the predetermined order in the album.

### SUMMARY OF THE INVENTION

Accordingly, an aspect of the present invention is to provide an apparatus and method of storing a number of music files by linking them with one another in consideration of a correlation between the music files, and a method of reproducing the stored music files thereof.

Another aspect of the present invention is to provide an apparatus and method of storing a number of music files by linking them with one another based on identification codes of the respective music files, and a method of reproducing the stored music files thereof.

Additional aspects and advantages of the invention will be set forth in part in the description which follows and, in part, will be obvious from the description, or may be learned by practice of the invention.

To achieve the above and/or other aspects of the present invention, there is provided an apparatus for storing music files, comprising a link process unit which links a number of input music files with one another in consideration of a correlation of the music files, and a music file storage unit which stores the music files linked with one another through the link process unit.

The link process unit may add link information to tag areas of the respective music files, and the link information may include identification (ID) code of a corresponding one of the music files, and ID codes of previous and next ones of the music files corresponding to the corresponding one of the music files. The link process unit may link the music files with one another based on an input order of the music files or a user designated order.

The link process unit may comprise an encoder which compresses the music files into an MP3 file format and links the music files with one another. Where the music files are MP3 music files, the link process unit may comprise a tag editor which edits tag areas of the MP3 music files and links the music files with one another.

To achieve the above and/or other aspects of the present invention, there is provided an apparatus for reproducing music files, comprising a music file storage unit which stores a number of music files respectively having linking information with respect to one another, and a music file reproduction unit which reads and reproduces the music files stored in the music file storage unit based on the linking information. The music file reproduction unit may read and reproduce the music files stored in the music file storage unit based on the linking information in response to a link play mode of the apparatus being enabled.

To achieve the above and/or other aspects of the present invention, there is provided another apparatus for reproducing music files, comprising a music file storage unit which stores a number of music files respectively having link information with respect to one another, a music file reproduction unit which reproduces the music files transmitted from the music file storage unit, and a control unit which determines a reproduction list based on the link information and controls the transmission of the music files stored in the music file storage unit to the music file reproduction unit based on the reproduction list. The control unit may determine the reproduction list and control the transmission of the music files stored in the music file storage unit to the music file reproduction unit based on the reproduction list, in response to a link play mode of the apparatus being enabled.

To achieve the above and/or other aspects of the present invention, there is provided an apparatus for storing and reproducing music files, comprising a link process unit which links a number of input music files with one another based on identification (ID) codes of the respective music files such that a corresponding one of the music files is linked with previous and next ones of the music files, a music file storage unit which stores the music files linked with one another through the link process unit, a music file reproduction unit which reproduces the music files transmitted from the music file storage unit, and a control unit which controls an order of the music files to be transmitted from the music file storage unit to the music file reproduction unit based on the link information on the music files stored in the music file storage unit. The control unit may control the order of the music files to be transmitted from the music file storage unit to the music file reproduction unit based on the link information, in response to a link play mode of the apparatus being enabled.

The apparatus may further comprise an interface unit which outputs the music files transmitted from the music file storage unit to an outside music file reproduction device, and outputs the music files transmitted from the outside music file reproduction device to the link process unit, under a control of the control unit.

To achieve the above and/or other aspects of the present invention, there is provided a method of storing and reproducing music files, the method comprising adding link information to each of a number of input music files in consideration of a correlation of the music files, storing the music files having the respectively added link information, and reproducing the stored music files in an order determined on the basis of the link information.

The reproducing of the stored music files may comprise reproducing the music files based on the link information in response to a link play mode being enabled.

The reproducing of the stored music files may comprise determining a reproduction list based on the link information, and reproducing the stored music files sequentially on the basis of the determined reproduction list.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram of an apparatus which stores and reproduces music files according to an embodiment of the present invention;

FIG. 2A shows an example of a link information format to link music files with one another according to the present invention;

FIG. 2B shows an example of an order to reproduce music files in a normal reproduction mode;

FIG. 2C shows an example of an order to reproduce music files in a link play mode according to the present invention; and

FIG. 3 is a flowchart illustrating a method of storing and reproducing music files according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

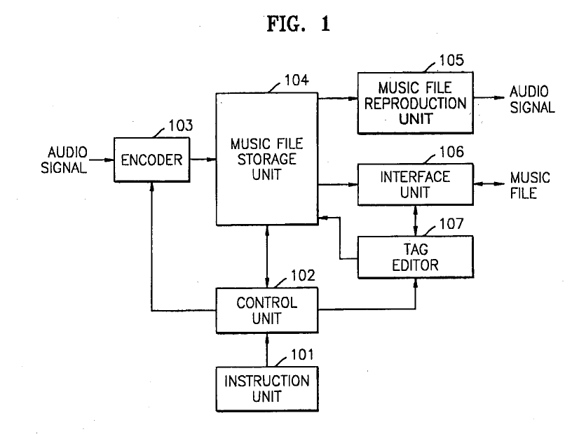

FIG. 1 shows an apparatus which stores and reproduces music files according to an embodiment of the present invention. The apparatus includes an instruction unit 101, a control unit 102, an encoder 103, a music file storage unit 104, a music file reproduction unit 105, an interface unit 106, and a tag editor 107.

A user may input information and an instruction through the instruction unit 101. For example, the user may input information to link music files and an instruction to enable a link play mode according to the present invention. The information to link the music files includes link order information and an instruction to add the link information.

Where the link order information is input through the instruction unit 101, a number of music files are linked in an order designated by the user. However, where the link order information is not input through the instruction unit 101, the music files are linked in the order in which the music files are input. Where a link play mode is enabled, the music files are reproduced in the order in which the music files are linked.

The control unit 102 may control the encoder 103 and the tag editor 107 to operate as a link process unit. That is, where audio signals are input to the encoder 103, the control unit 102 enables the encoder 103 to operate as the link process unit. However, where the audio signals are input through the interface unit 106, the control unit 102 enables the tag editor 107 to operate as the link process unit.

The audio signals input to the encoder 103 are signals that are not compressed into a MP3 format. The audio signals can be provided from the outside, or from an audio reproduction device (not shown) connected to the apparatus shown in FIG. 1. The audio device may be incorporated into a single system with the apparatus shown in FIG. 1.

Where the encoder 103 is enabled to operate as the link process unit under the control of the control unit 102, the encoder 103 compresses the input audio signals into MP3 files, and links the compressed MP3 files in consideration of a correlation between the MP3 files. That is, where the encoder 103 is enabled to operate as the link process unit, but the link order information is not provided thereto, the encoder 103 links the MP3 files in the order in which the MP3 files are input. However, where the encoder 103 is enabled to operate as the link process unit, and the link order information is provided thereto, the encoder 103 links the audio signals that have been compressed into MP3 files based on the link order information.

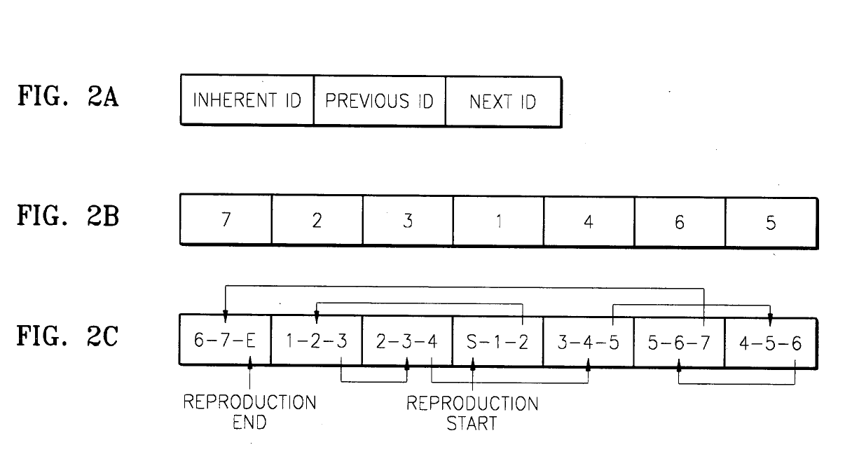

Linking operations are based, for example, on identification (ID) codes of the compressed MP3 files. That is, as shown in FIG. 2A, tag areas of the present input MP3 file are filled with link information including an ID code of the present input MP3 file (an inherent ID code), an ID code of a previously input and compressed MP3 file (a previous ID code), and an ID code of an MP3 file to be input and compressed next (a next ID code). The ID codes are produced where the input audio signals are compressed into the MP3 files on the basis of the added information of the audio signals.

FIG. 2A shows an example of link information format to link music files with one another in the order in which the music files are input. In a case of linking the music files in an order designated by a user, the previous ID code can be the ID code of the MP3 file that the user wished to reproduce before the corresponding MP3 file, and the next ID code can be the ID code of the MP3 file that the user wishes to reproduce after the corresponding MP3 file.

Compressing the audio signals into MP3 files in the encoder 103 follows, for example, a method known or to be known. The MP3 files having the link information added through the encoder 103 are stored in the music file storage unit 104.

The audio signals input to the tag editor 107 are compressed into MP3 files. Therefore, where the tag editor 107 is enabled to operate as the link process unit under the control of the control unit 102, the tag editor 107 edits the input MP3 files so as to add the link information as shown in FIG. 2A in the tag areas of the MP3 files. In this case, where the link order information is provided from the control unit 102, the tag areas are edited so as to add the link information based on the link order information in the tag areas of the respective MP3 files. However, where the link order information is not provided from the control unit 102, the tag areas are edited so as to add the link information based on the input order of the MP3 files in the tag areas. The link information utilizes the ID codes of the MP3 files as described with reference to the encoder 103. The MP3 files having the tag areas edited through the tag editor 107 are stored in the music file storage unit 104.

The music file storage unit 104 stores a number of MP3 files. The format of the MP3 files includes the link information added where the encoder 103 or the tag editor 107 is enabled to operate as the link process unit.

The interface unit 106 receives the MP3 files transmitted from the audio reproduction unit (not shown) as described above and sends the MP3 files to the tag editor 107, or transmits the MP3 files output from the music file storage unit 104 to the audio reproduction unit.

The music file reproduction unit 105 reproduces the MP3 files output from the music file storage unit 104. That is, the MP3 files are decoded and output.

Where an instruction requesting a normal reproduction mode is input through the instruction unit 101, the control unit 102 controls the music file storage unit 104 so as to reproduce the stored music files on the basis of the names of the music files as in a conventional way. Accordingly, a reproduction order of the music files can be arranged as shown in FIG. 2B. The numbers shown in FIG. 2B are the ID codes of the MP3 files based on the order that the MP3 files are input. However, since the MP3 files are rearranged on the basis of their file names, the MP3 files are transmitted to the music file reproduction unit 105 or the interface unit 106 in the order shown in FIG. 2B. The control unit 102 controls whether the MP3 files output from the music file storage unit 104 are transmitted to the music file reproduction unit 105 or the interface unit 106.

Where an instruction requesting a link play mode is input through the instruction unit 101, the control unit 102 determines a reproduction list based on link information that is added in a tag area of each MP3 file in the format shown in FIG. 2A. Further, based on the determined reproduction list, the control unit 102 controls the outputs of the MP3 files stored in the music file storage unit 104. Accordingly, the MP3 files output from the music file storage unit 104 are arranged, for example, in the order shown in FIG. 2C. Referring to FIG. 2C, the control unit 102 controls the music file storage unit 104, by using the reproduction list determined on the basis of the link information, to output an MP3 file to which “S-1-2” link information is added first among the MP3 files stored in the music file storage unit 104. Thereafter, the control unit 102 controls the music file storage unit to output an MP3 file having “1-2-3” link information, and thereafter, an MP3 file having “2-3-4” link information. The control process is continued in the order shown in FIG. 2C. Where an MP3 file having “6-7-E” link information is output, the control unit 102 stops the output operations of the music file storage unit 104.

While the present invention has been described with a single system which stores and reproduces MP3 files, it is understood that the present invention can be applied to a separated system in which an apparatus that stores audio signals by compressing them into MP3 files and adds link information thereto is separated from an apparatus that receives and reproduces the MP3 files to which the link information is added.

Furthermore, although the control unit 102 has been described to control the output operations of the music file storage unit 104 after determining the reproduction list based on the link information, it is understood that the control unit 102 can directly control the output operations of the music file storage unit 104 based on the information included in the tag area of each music file without determining the reproduction list.

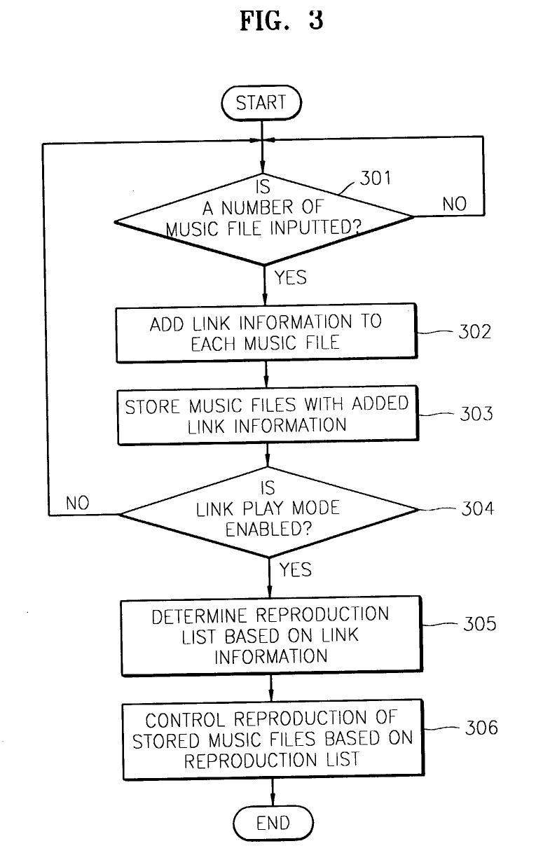

FIG. 3 shows a flowchart illustrating a method of storing and reproducing music files according to the present invention.

In operation 301, it is determined whether a number of music files is input. The music files can be either MP3 files or normal music files that are not compressed into the MP3 files. As an illustrative purpose, it is assumed that the input music files are the MP3 files hereinbelow.

Where it is determined that a number of music files is input in the operation 301, link information is added to the respective music files in operation 302. The link information utilizes, for example, identification (ID) codes of the respective music files. The link information is added into tag areas of the respective music files. A method of adding the link information is described with reference to FIG. 1, and a format of the link information is shown in FIG. 2A.

In operation 303, the music files to which the link information is added are stored in, for example, the music file storage unit 104. Thereafter, it is determined whether a link play mode is enabled in operation 304. Where the link play mode is not enabled in the operation 304, the process returns to the operation 301.

Where the link play mode is enabled in the operation 304, a reproduction list is determined on the basis of the link information added to the respective music files in operation 305. Based on the reproduction list determined in the operation 305, a reproduction of the stored music files is controlled in operation 306.

As described above, according to the present invention, since a number of music files is linked and stored in consideration of a correlation of the music files, a user can reproduce the number of music files in the order in which the correlation is considered. For example, where the user wishes to listen to a number of music contained in a same album, it is possible to listen to music in the order in which the music files are in the album. Furthermore, since a number of music files can be linked and saved in an order designated by the user, it is possible to listen to music in the order in which the user wishes to listen.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus for storing music files, comprising:
a link process unit which links a number of input music files with one another in consideration of a correlation of the music files; and
a music file storage unit which stores the music files linked with one another through the link process unit.

2. The apparatus for storing music files according to claim 1, wherein:
the link process unit adds link information to tag areas of the respective music files, and
the link information includes an identification (ID) code of a corresponding one of the music files, and ID codes of previous and next ones of the music files corresponding to the corresponding one of the music files.

3. The apparatus for storing music files according to claim 1, wherein the link process unit links the music files with one another based on an input order of the music files.

4. The apparatus for storing music files according to claim 1, wherein the link process unit links the music files with one another based on a user designated order.

5. The apparatus for storing music files according to claim 1, wherein the link process unit comprises an encoder which compresses the music files into a MP3 file format and links the music files with one another.

6. The apparatus for storing music files according to claim 1, wherein:
the music files are MP3 music files, and
the link process unit comprises a tag editor which edits tag areas of the respective MP3 music files and links the MP3 music files with one another.

7. An apparatus for reproducing music files, comprising:
a music file storage unit which stores a number of music files respectively having linking information with respect to one another; and
a music file reproduction unit which reads and reproduces the music files stored in the music file storage unit based on the linking information.

8. An apparatus for reproducing music files, comprising:
a music file storage unit which stores a number of music files respectively having link information with respect to one another;
a music file reproduction unit which reproduces the music files transmitted from the music file storage unit; and
a control unit which determines a reproduction list based on the link information and controls the transmission of the music files stored in the music file storage unit to the music file reproduction unit based on the reproduction list.

9. The apparatus for reproducing music files according to claim 8, wherein the link information includes an identification (ID) code of a corresponding one of the music files, and ID codes of previous and next ones of the music files corresponding to the corresponding one of the music files.

10. The apparatus for reproducing music files according to claim 7, wherein the linking information includes an identification (ID) code of a corresponding one of the music files, and ID codes of previous and next ones of the music files corresponding to the corresponding one of the music files.

11. An apparatus for storing and reproducing music files, comprising:
a link process unit which links a number of input music files with one another based on identification (ID) codes of the respective music files such that a corresponding one of the music files is linked with previous and next ones of the music files;
a music file storage unit which stores the music files linked with one another through the link process unit;
a music file reproduction unit which reproduces the music files transmitted from the music file storage unit; and
a control unit which controls an order of the music files to be transmitted from the music file storage unit to the music file reproduction unit based on the link information on the music files stored in the music file storage unit.

12. The apparatus for storing and reproducing music files according to claim 11, wherein:
the link process unit adds link information to tag areas of the respective music files, and
the link information includes the identification codes of the corresponding one of the music files, and the previous and next ones of the music files corresponding to the corresponding one of the music files.

13. The apparatus for storing and reproducing music files according to claim 11, further comprising an interface unit which outputs the music files transmitted from the music file storage unit to an outside music file reproduction device, and outputs the music files transmitted from the outside music file reproduction device to the link process unit, under a control of the control unit.

14. The apparatus for storing and reproducing music files according to claim 13, wherein the link process unit comprises a tag editor which edits tag areas of the music files.

15. The apparatus for storing and reproducing music files according to claim 11, wherein the link process unit comprises an encoder which compresses the music files into an MP3 file format and links the music files with one another.

16. A method of storing and reproducing music files, the method comprising:
adding link information to each of a number of input music files in consideration of a correlation of the music files;
storing the music files having the respectively added link information; and
reproducing the stored music files in an order determined based upon the link information.

17. The method for storing and reproducing music files according to claim 16, wherein the adding of the link information comprises adding the link information having an identification (ID) code of a corresponding one of the music files, and ID codes of previous and next ones of the music files corresponding to the corresponding one of the music files.

18. The method for storing and reproducing music files according to claim 16, wherein the adding of the link information comprises adding the link information while the music files are compressed and encoded in an MP3 file format, in response to the music files not being MP3 music files.

19. The method for storing and reproducing music files according to claim 16, wherein the adding of the linking information comprises adding the linking information by editing tag areas of the music file, in response to the music files being MP3 music files.

20. The method for storing and reproducing music files according to claim 16, wherein the reproducing of the stored music files comprises:
determining a reproduction list based on the link information; and
reproducing the stored music files sequentially based upon the determined reproduction list.

21. The apparatus for reproducing music files according to claim 7, wherein the music file reproduction unit reads and reproduces the music files stored in the music file storage unit based on the linking information in response to a link play mode of the apparatus being enabled.

22. The apparatus for reproducing music files according to claim 8, wherein the control unit determines the reproduction list and controls the transmission of the music files stored in the music file storage unit to the music file reproduction unit based on the reproduction list, in response to a link play mode of the apparatus being enabled.

23. The apparatus for reproducing and reproducing music files according to claim 11, wherein the control unit controls the order of the music files to be transmitted from the music file storage unit to the music file reproduction unit based on the link information, in response to a link play mode of the apparatus being enabled.

24. The method for storing and reproducing music files according to claim 16, wherein the reproducing of the stored music files comprises reproducing the music files based on the link information in response a link play mode being enabled.

25. An apparatus for storing/reproducing music files, comprising:
a link process unit which links the music files by one of adding link information to tag areas of the respective music files and editing the tag areas of the respective music files; and
a music file storage unit which stores the music files linked with one another through the link process unit.

26. The apparatus according to claim 25, wherein the link information includes an identification (ID) code of a corresponding one of the music files, and ID codes of previous and next ones of the music files corresponding to the corresponding one of the music files.

27. The apparatus according to claim 25, wherein the link process unit links the music files in an order which the music files are input in response to the link information not being provided to the link process unit.

28. The apparatus according to claim 25, wherein the link process unit edits the tag areas of the respective music files to link the music files in response to the music files being in a predetermined-compressed format.

29. The apparatus according to claim 25, wherein the link process unit compresses and links the music files in response to the music files being in un-compressed music format.

30. The apparatus according to claim 25, further comprising a music file reproduction unit which reads and reproduces the music files stored in the music file storage unit based on one of the link information and the edited tag areas.

31. The apparatus according to claim 30, further comprising a control unit which controls an order of the music files to be transmitted from the music file storage unit to the music file reproduction unit based on one of the link information and the edited tag areas.
